(19) United States
(12) Patent Application Publication
(10) Pub. No.: US 2012/0144746 A1
(43) Pub. Date: Jun. 14, 2012

(54) ACCESS PANEL

(76) Inventors: Robert David Black, Bicester (GB); John Alexander Black, Bicester (GB)

(21) Appl. No.: 13/390,811

(22) PCT Filed: Aug. 18, 2010
(86) PCT No.: PCT/GB2010/051363

§ 371 Date: Feb. 16, 2012

(30) Foreign Application Priority Data
Aug. 18, 2009 (GB) 0914424.7

(51) Int. Cl. E06B 9/84

(52) U.S. Cl. 49/56

(57) ABSTRACT

An access panel for use in conjunction with a horizontal opening; recesses (41, 42) incorporated in the sides of longitudinal edges of the horizontal opening the access panel (11) comprising a parallel array (12) of members (14, 15, 16) with a longitudinal axis; the lateral extent (W) of the array (12) corresponding to a lateral extent (D) of the opening and first (17) and second (18) end members of the array (12) defining a length (L) of the panel (12) characterised by at least two pantograph units (20, 21) extending between the first (17) and second (18) end members; each member (14 16, etc) in the parallel array (12) being pivotably linked to each pantograph unit; the combination of members (14, 15, 16 etc) and units (20, 21) providing for the panel (11) to function as a planar structure and enabling the (L) of the panel (11) to be varied between a first configuration wherein the panel has a minimum length (L1) measured between the first (17) and second (18) end members; a second configuration wherein the panel has a maximum length (L2) measured between the first (17) and second (18) end members or an intermediate configuration having a length intermediate the minimum length (L1) and the maximum length (L2).

### TECHNICAL FIELD

This invention relates to an access panel. It is particularly, but not exclusively, concerned with a safety device for use in connection with a horizontal floor opening through which an individual could inadvertently fall.

### BACKGROUND ART

A number of industries make use of a work area in which wheeled units are worked on. Typically a garage or other workspace for car maintenance, repair or construction needs to be able to access a vehicle from any direction. In order to work on the underside of the vehicle there is a need for a pit over which the vehicle can be placed to enable an operative to enter the pit to access the underside of the vehicle. With a vehicle in place over a pit opening so as to fully cover the opening then inadvertent falling is prevented. However once the vehicle is removed from the pit opening the pit opening becomes a hazard until some form of barrier is put in place.

Various methods have been used to prevent inadvertent entry into such a pit. These include a vertical barrier extending around the pit periphery or baulks of timber inserted to lie on a rim about the pit opening so as to be flush with surrounding floor area. However these methods require action by somebody and take time to carry out. In addition if the person working in the pit on a vehicle subsequently climbs out and the vehicle is moved away from the pit the pit opening is left unguarded until a person arrives to rectify the situation. Whatever physical barrier is used can be supplemented by signs, lights or sounding means.

In our co-pending application PCT/GB2009/050460 there is described a retractable safety device for use in regulating entry to a hazard area from an access area comprising: a parallel array of members each member in the array having—a first end pivotally attached to a first side rail to which each member is pivotally attached by a first end of each array member; a second side member to which each member in the array is pivotally attached by a second end of each array member; the array and first and second side arrays being displaceable in a plane between a first, working, configuration in which the first and second side members are relatively wide apart; and a second, stowage, configuration where the first and second side members are relatively close; at least two slide arms, each slide arm being located on, and pivotally connected to, the second side member; the slide arms being spaced apart on the second side member; a slider mounted on each side arm adapted to slide along the slide arm on which it is mounted, each slider including means whereby the slider can be secured to a region in or near the hazard area so as to permit the slide arm to be displaceable relative to the slider; and stop means to limit the extent of travel of the slide arm relative to the slider so as to define the second, stowage, configuration; the device providing that with the array in the first, working, configuration the array serves to obstruct passage from the access area into the hazard area; and with the array in the second, storage, configuration the array is withdrawn from obstructing passage from the access area into the hazard area. Hereafter a safety device of this type will be referred to a being ‘of the type described’.

When a vehicle covers an entire pit opening then it provides a complete barrier to inadvertent pit entry. However access to the pit for work on the vehicle is also prevented. In the event a vehicle covers only a part of the pit opening access to the pit to work on the vehicle is readily available but the exposed section of the opening remains a hazard.

### DISCLOSURE OF INVENTION

An access panel for use in conjunction with a horizontal opening; recesses (41, 42) incorporated in the sides of longitudinal edges of the horizontal opening the access panel (11) comprising a parallel array (12) of members (14, 15, 16) with a longitudinal axis; the lateral extent (W) of the array (12) corresponding to a lateral extent (D) of the opening and first (17) and second (18) end members of the array (12) defining a length (L) of the panel (12) characterised by at least two pantograph units (20, 21) extending between the first (17) and second (18) end members; each member (14-16, etc) in the parallel array (12) being pivotably linked to each pantograph unit; the combination of members (14, 15, 16 etc) and units (20, 21) providing for the panel (11) to function as a planar structure and enabling the length (L) of the panel (11) to be varied between a first configuration wherein the panel has a minimum length (L1) measured between the first (17) and second (18) end members; a second configuration wherein the panel has a maximum length (L2) measured between the first (17) and second (18) end members or an intermediate configuration having a length intermediate the minimum length (L1) and the maximum length (L2).

According to a first preferred version of the present invention lateral ends of at least some of the members (14-16, etc) of the array (12) are adapted for sliding on a support means to provide for the panel to be readily varied in length by low frictional contact between the adapted ends and the support means.

### DESCRIPTION OF DRAWINGS

An exemplary embodiment of the invention will now be described with reference to the accompanying drawings of an access panel of which:

FIG. 1 is a diagrammatic plan view;

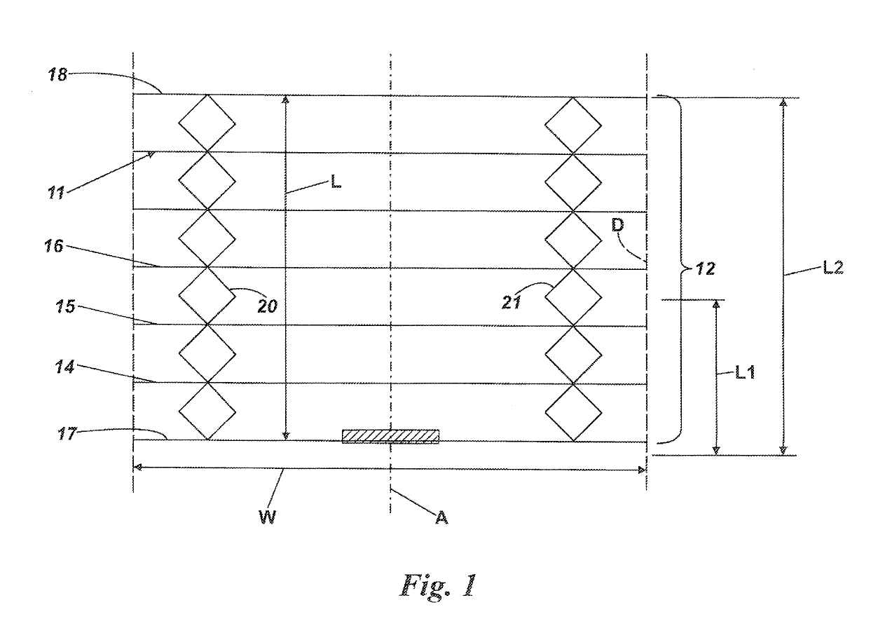

FIG. 2 is a view from above of an installed access panel; and

FIG. 3 is a perspective view of the panel of FIG. 2

### MODE FOR CARRYING OUT THE INVENTION

The figures variously show an access panel 11 made up of a parallel array 12 of members (typically members 14, 15, 16) with a longitudinal axis A. Lateral extent W of the array 12 corresponds to lateral extent of opening D. First end member 17 of the array and second end member 18 between them define the length L of the panel 11 which length can be varied as will be described hereafter.

Pantograph unit 20, 21 extends between the first and second end members 17, 18. The pantograph 20 (pantograph 21 being identical in form and function) comprises a sequence of strips pivotably attached at the centres to a member of the array 12 and at their end to the ends of adjacent strips so providing for the array to be altered in length while the members of the array are maintained parallel to and equidistant from, one another. If necessary a locking device can be used so that at a given length of the array the distance between the first and second end members cannot be changed inadvertently.

Each member 14, 15, 16, 17, 18 etc. in the parallel array 12 is pivotably linked to each pantograph unit 20, 21 to provide for a combination of pivotably linked members and units resulting in the panel 11 functioning as a planar structure and enabling the length of the panel 11 to be varied longitudinally between:
a first configuration wherein the panel 11 can be maintained at a minimum length L1 measured between the first and second end members 17, 18; or
a second configuration wherein the panel can be maintained at a maximum length L2 measured between the first and second end members 17, 18; or
any intermediate length intermediate the minimum and maximum lengths.

The extremities of the members (14-18 etc) are provided with a low friction coating to enable the extremities to slide readily in channels recesses (41, 42) incorporated in the sides of longitudinal edges of the pit 40.

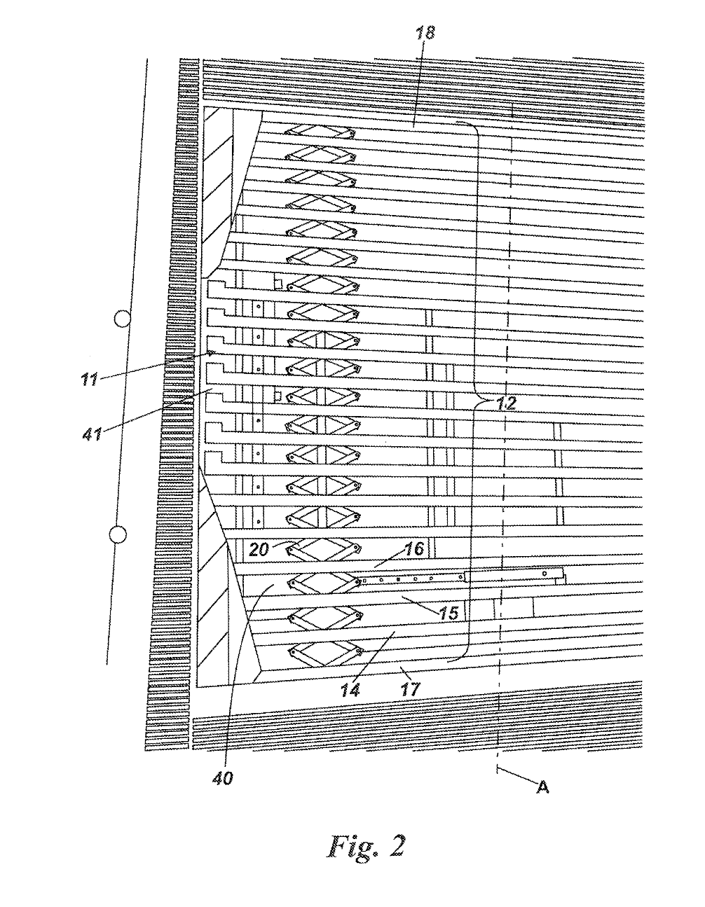

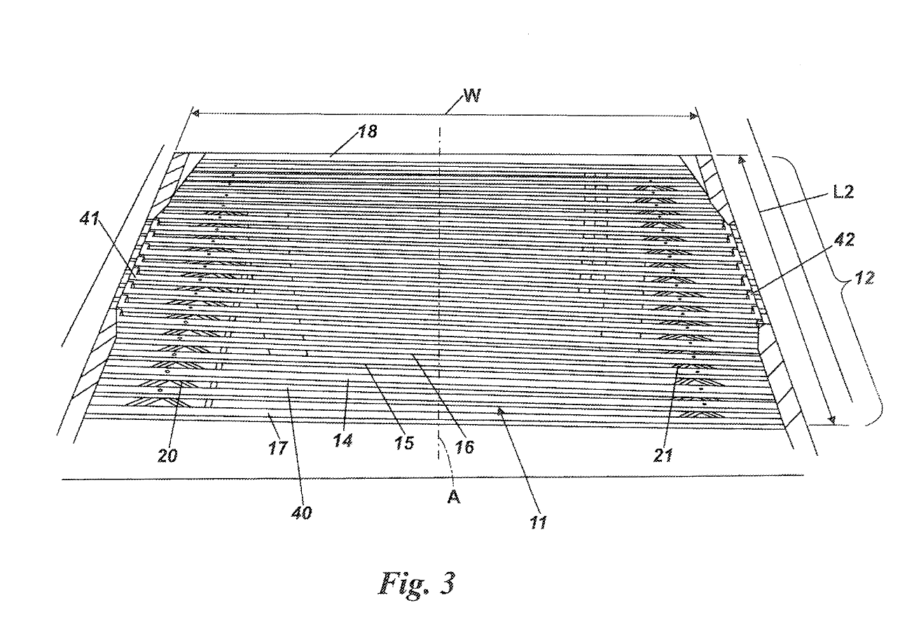

As shown in FIGS. 2 and 3 the panel 11 is located over a pit 40 by being mounted by means of the extremities of the members in the array 12 in recesses 41, 42 incorporated in the sides of longitudinal edges of the pit periphery 43. The extremities of the members (14-18, etc) are provided with a low friction coating to enable the extremities to slide readily in channels 41, 41 when the length of the array 12 is varied as outlined earlier.

The panel 11 provides for a number of uses. For example in the event the pit 40 is partially covered by a vehicle and co-extensively by a retractable safety device the subject of our co-pending application PCT/GB2009/050460 then the uncovered section can be readily closed by means of the panel 11 with its length L set appropriately. The panel 11 is relatively light and easily handled and positioned so encouraging its use by an operative in contrast to conventional safety means.

### INDUSTRIAL APPLICABILITY

The invention provides a safety device which can be readily set up and readily removed particularly, but not exclusively, for a pit for vehicle servicing. The device is readily mounted whether in an existing pit installation or in a new one.

1. An access panel for use in conjunction with a horizontal opening; recesses (41, 42) incorporated in the sides of longitudinal edges of the horizontal opening the access panel (11) comprising a parallel array (12) of members (14, 15, 16) with a longitudinal axis; the lateral extent (W) of the array (12) corresponding to a lateral extent (D) of the opening and first (17) and second (18) end members of the array (12) defining a length (L) of the panel (12) characterised by at least two pantograph units (20, 21) extending between the first (17) and second (18) end members; each member (14-16, etc) in the parallel array (12) being pivotally linked to each pantograph unit; the combination of members (14, 15, 16 etc) and units (20, 21) providing for the panel (11) to function as a planar structure and enabling the length (L) of the panel (11) to be varied between a first configuration wherein the panel has a minimum length (L1) measured between the first (17) and second (18) end members; a second configuration wherein the panel has a maximum length (L2) measured between the first (17) and second (18) end members or an intermediate configuration having a length intermediate the minimum length (L1) and the maximum length (L2).

2. An access panel as claimed in claim 1 characterised by lateral ends of at least some of the members (14-16, etc) of the array (12) being adapted for sliding on a support means to provide for the panel to be readily varied in length by low frictional contact between the adapted ends and the support means.
